(19) United States
(12) Patent Application Publication
(10) Pub. No.: US 2017/0097981 A1
(43) Pub. Date: Apr. 6, 2017

(54) APPARATUS AND METHOD FOR DATA COMPRESSION

(71) Applicant: GURULOGIC MICROSYSTEMS OY, Turku (FI)

(72) Inventors: Ossi KALEVO, Akaa (FI); Tuomas KARKKAINEN, Turku (FI)

(21) Appl. No.: 15/316,046

(22) PCT Filed: Jun. 11, 2015
(86) PCT No.: PCT/EP2015/025031

§ 371 Date: Dec. 2, 2016

(30) Foreign Application Priority Data
Jun. 11, 2014 (GB) 1410445.9

(51) Int. Cl. G06F 17/30; G06F 7/60

(52) U.S. Cl. CPC G06F 17/30598; G06F 17/30312; G06F 7/60

(57) ABSTRACT

An apparatus is operable to compress first data to generate corresponding compressed second data. The apparatus includes a data processing arrangement which is operable: to arrange the first data into a configuration of data blocks; to compute one or more parameters describing the data blocks and, based upon categories related to the one or more parameters, to search one or more databases and/or data base elements, for subsequent matching of the data blocks in the one or more databases for corresponding matching elements; for the matched data blocks and elements, to generate a data set including reference values identifying the elements and containing the categories or information about the categories; and to generate the compressed second data by including therein the reference values containing the categories or information about the categories.

### CROSS-REFERENCE TO RELATED APPLICATIONS

This application is a National Stage of PCT/EP2015/025031, filed Jun. 11, 2015, which claims priority under 35 U.S.C. §119 to GB Application No. 1410445.9, filed Jun. 11, 2014, all of which are incorporated herein by reference in their entirety.

### TECHNICAL FIELD

The present disclosure relates to apparatus for compressing data to generate corresponding compressed data. Moreover, the present disclosure concerns methods of using aforesaid apparatus for compressing data to generate corresponding compressed data. Furthermore, the present disclosure relates to systems and codecs including aforesaid apparatus, as well as corresponding apparatus for decompressing the compressed data to generate corresponding decompressed data. Additionally, the present disclosure relates to a computer program product comprising a non-transitory computer-readable storage medium having computer-readable instructions stored thereon, the computer-readable instructions being executable by a computerized device comprising processing hardware to execute aforementioned methods. The data relates, for example, to captured image data, audio data, video data, graphics data, measurement data, sensor data, DNA data, genomic data, but is not limited thereto.

### BACKGROUND

Data compression is well known and enables less communication network resources and less data storage capacity to be utilized when communicating and storing given data, respectively. Data compression can be lossless, when information is not lost as a result of applying data compression; alternatively, data compression can be lossy, when a degree of loss of information occurs as a result of applying data compression. When compressing source data to generate corresponding compressed data, it is often beneficial to employ one or more elements (E) to represent one or more parts of the source data, for example by way of one or more reference codes (R) which uniquely define corresponding one or more elements (E).

A very advanced data processing method is described in a United States patent application U.S. Ser. No. 13/715,405, wherein the method is employable for compressing all kinds of data blocks present in source data via use of many different databases and database elements (E); however, it is feasible to provide further enhancements to such advanced methods, for example further enhancements related to issues concerning shapes of the database elements. In a data generator described in the United States patent application U.S. Ser. No. 13/715,405, there is described a faster method of searching data blocks from among database elements for static or dynamic databases by utilizing one look-up table.

Known databases often cannot be used efficiently for processing all different kinds of data blocks present in the source data. For example, if there is no feasible way to categorize references in the databases, slower searches within the databases occur. Known database reference mechanisms often do not enable appropriate components to be used for categorizing references, for example by means of describing shapes of data blocks present in source data in such a manner that similar shapes can be searched without a large amount of data block value comparisons needing to be performed. Moreover, if the known databases include a large number of components to be searched, the data block search performed on the databases is too slow, namely considerable computing resources are required for its implementation. Conversely, if the databases include only a small choice of components, there are not enough different data blocks that can be used for achieving high quality data compression.

A further problem which is encountered is that there is a need to optimize sizes of databases for performing searches in respect of data blocks. Contemporary known databases often include certain given data which is closely related to other data in the databases, all of which potentially need to be searched.

In an earlier patent document GB2362055A (Clearstream Tech Ltd.) (“Image Compression using a Codebook”), there is described an apparatus for processing image data. The apparatus includes an arrangement for dividing an incoming image into a plurality of data blocks comprising pixels. Moreover, the apparatus includes a code book arrangement for storing a plurality of data blocks having mutually different predetermined combinations of pixels, wherein each of the combinations is associated with corresponding unique identifying data. Furthermore, the apparatus includes an arrangement for comparing each data block of the image with the stored data blocks for identifying the combination of pixels from the code book arrangement which substantially matches the combination of pixels in the data block. There is also included an arrangement for outputting the unique identifying data associated with the matching combination. In operation, the apparatus is required to search the code book arrangement for each data block stored therein, which is a computationally intensive and laborious task, especially when the number of data blocks stored in the code book arrangement is very large.

In an earlier patent document U.S. Pat. No. 5,838,833A (Minolta Co. Ltd.)(“Fractal image compression method and device, and fractal image restoration method and device”), there is described a device employing a method of executing image compression by dividing an image into data blocks which are then encoded and compressed by finding similarities between the data blocks. When finding such similarities, speed of finding similarities, namely making comparisons in other words, is increased by varying the size of the data blocks when image edges are present, by comparing the data blocks. Image data blocks are compared to pre-stored image patterns rather than other portions of the image, using raw data rather than compressing data. Moreover, there are also utilized inspection areas to increase a possibility of finding most similar areas as quickly as possible.

It will be appreciated that the method described in the earlier patent document U.S. Pat. No. 838,833 was designed to code images with the help of fractals. Thus, a system employed does not actually have a database, but instead generates a dynamic ‘database’ from domain blocks, based on the contents of an image to be encoded, in such a way that the same generated domain block can be used in other areas of the same image as well for coding a block. The earlier patent document U.S. Pat. No. 838,833 refers to data blocks and is thus rather different from embodiments of the present disclosure. The earlier document U.S. Pat. No. 838,833 does not mention video or other types of data at all; it does not even suggest that the domain blocks of a previous image could be used for coding the next image. Moreover, static databases are not used at all in the described system.

However, techniques employed in these earlier documents GB2362055A and U.S. Pat. No. 5,838,833A are not sufficiently effective when encoding data, for example image data, to a high resolution using more modest computing resources, for example in mobile communication devices.

### SUMMARY

The present disclosure seeks to provide an apparatus which is operable to compress data in an enhanced manner to generate corresponding compressed data.

Moreover, the present disclosure seeks to provide a method of compressing data in an enhanced manner to generate corresponding compressed data.

According to a first aspect, there is provided an apparatus for compressing first data (D1) to generate corresponding compressed second data (D2), wherein the apparatus includes a data processing arrangement which is operable to arrange at least a portion of the first data (D1) into a configuration of data blocks, characterized in that the data processing arrangement is further operable:

(i) to compute one or more parameters describing the data blocks (110, DB), the one or more parameters including a plurality of sub-portion parameters (A1, A2, . . . , AN) describing sub-portions of the data blocks (110, DB), wherein the plurality of sub-portion parameters (A1, A2, . . . , AN) includes at least one of: MAR (mean in amplitude ratio) mean, average, standard deviation, variance, amplitude, median, mode, minimum value, maximum value, CRC (cyclic redundancy check), hash, an amount of levels;

(ii) to search, based upon categories related to the one or more parameters, one or more databases and/or data base elements, for subsequent matching of the data blocks (110, DB) to corresponding matching elements (120, E) in the one or more databases (130), wherein the data blocks (110, DB) are matched to their corresponding matching elements (120, E) by utilizing the plurality of sub-portion parameters (A1, A2, . . . , AN);

(iii) for the matched data blocks (DB) and elements (E), to generate a data set including reference values (R) identifying the elements (E) and containing the categories or information about the categories; and

(iv) to generate the compressed second data (D2) by including therein the reference values (R) containing the categories or information about the categories.

The invention is of advantage in that the apparatus, for example when implemented as an encoder, is operable to employ separate information, for example category or “gategory” information, when matching elements (E) to data blocks (DB) which renders searching for matching more efficient, for example by enabling smaller databases of elements (E) to be employed.

In the invention, the search is conducted with help of categories. Further, the search can also be conducted based on transformations needed to match the category of a database element to a data block as will be elucidated later. Both categories and transformations can then be used in the delivery of encoded compressed data. Use of categories results in a multi-level searching process which improves performance, namely makes searching faster using category, and then resolving the search for a given data block (DB) based upon the searched category. The matching of elements however can be used by using any conventional method. However, sometimes merely categorizing can be sufficient to do even the matching.

It will be appreciated that the databases in which searches are executed are static databases and/or dynamic databases. A static database is such a database whose elements, namely data blocks, are always determined and/or computed in a mutually similar fashion, namely they are immutable, irrespective of when the element is requested and used in operation. In other words, when a search is conducted in a given same static database, using a same index and same parameters, it is always a corresponding same element, namely data block, that is received as response to the request. In contradistinction, a dynamic database is such a database that elements in it can be swapped and/or new elements can be added. Therefore, depending on when an element is requested, a search conducted in a dynamic database may yield very different elements, namely data blocks, depending upon a time when the dynamic database is searched. This also means that, pursuant to the embodiments of the current disclosure, computing parameters to describe the data blocks, based on which a database and its elements can be categorized, takes place in a static database only once but in a dynamic database continuously, as database elements in the latter database are changed (elements can be added and removed).

Moreover, it will also be appreciated that parameters used in requesting for a given element may also contain information about one or more transformations used in conjunction with the given element. Moreover, a reference to a database element may contain information on a corresponding category that is used, and/or a transformation that is used. Using categories often enables the use of much smaller databases as aforementioned. Alternatively, in an example case of a data block, database categories are advantageously used, thereby enabling faster inspection to be achieved to determine whether the given data block needs to be searched in that particular database.

With the help of a category of a given data block and categories of a given database or its individual elements, it is feasible, in a faster manner, to receive information regarding which kinds of transformations that are advantageously used to search for the given data block, together with one or more particular database elements. When the suitable transformations have been determined, remaining searching to be performed for the given data block can be performed in a more efficient and focused manner, thereby reducing overall computational effort required.

Dynamic databases can also be created in such a way that they contain elements originating from a static database. In such a case, a dynamic database reference can usually be expressed with less bits than the original static database reference would require. Correspondingly, a new static database can be created based upon a dynamic database in case a current version of the dynamic database is desired to be reused temporally later. When a static database is created from a dynamic database, then existing references of the dynamic database can be kept unaltered, or optionally, the elements of the dynamic database can be reorganized, for example purposes of categorizing and/or for achieving a faster search, in which case the elements are advantageously issued new references.

In addition to database coding methods, other coding methods can be used as well in coding a given data block. Examples of other methods are DC (offset), DCT (discrete cosine transform), slide, line, interpolation, extrapolation, multilevel coding, predicting methods, delta-based methods, and similar. Moreover, all these other coding methods can be used as such, or can be used with additional side information, namely supporting information, for example residual information. It will also be appreciated that the data blocks being coded can also be of mutually different sizes and shapes. The sizes and shapes of the data blocks can be known by a corresponding decoder to the encoder, or the encoder may deliver information about blocks, their sizes and their shapes, for example together with split/combine bits and/or with coordinates and/or with some other relevant information.

When searching for an optimal database element in the database, or when computing to best method for coding a given data block, then the selection may be based, for example, on the Rate Distortion (RD) value. The RD value can be used to compare encoding results produced for data blocks of different size, for example 2×2, 16×16, 64×64, and so forth, with each other and thus find an optimal selection for use when encoding the data blocks. The RD value is advantageously computed as follows in Equation 1 (Eq. 1):

RD=D+R*L Eq. 1

wherein:

L=a Lagrange multiplier;

D=a distortion D (for example SAD, SSD) between an original data block and a corresponding decoded data block; and

R=a data size R used by the method or a database element.

The value of the Lagrange multiplier “L” depends on how good a quality was desired before encoding. A small Lagrange multiplier favors a good reconstruction quality, but increases the data size to be transmitted from an encoder to a corresponding decoder. Correspondingly, a large Lagrange multiplier favors a small data size to be transmitted, but decreases a quality of a reconstructed output at the decoder. The smaller the RD value that is achieved for a given data block, the better the element or coding method corresponds to the original data block, using as few encoded bits as possible.

However, if lossless coding is required when communicating data from the encoder to the decoder, then distortion cannot be allowed at all. In lossless coding, the selection is made based solely on the data size “R” value, using only those elements or methods in encoding computations that yield a perfect lossless reconstruction for the given data block. When only the data size “R” value is used as basis for selection, then the selection will fall on that particular element or method which is able to produce a reconstructed data block that is identical with a corresponding original data block, and which is able to do so using the least amount of encoded bits to be communicated from the encoder to a corresponding decoder.

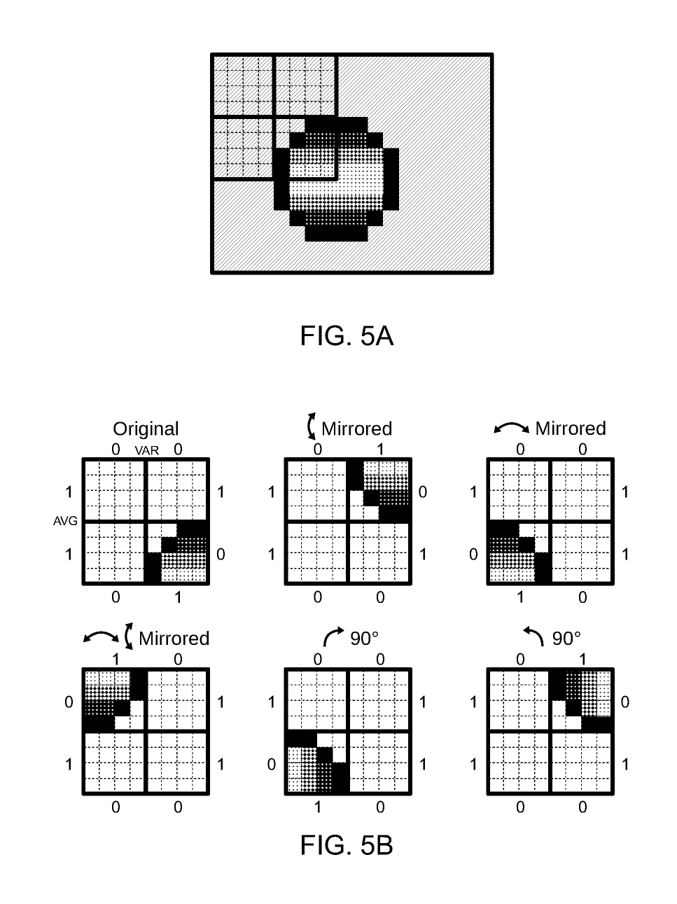

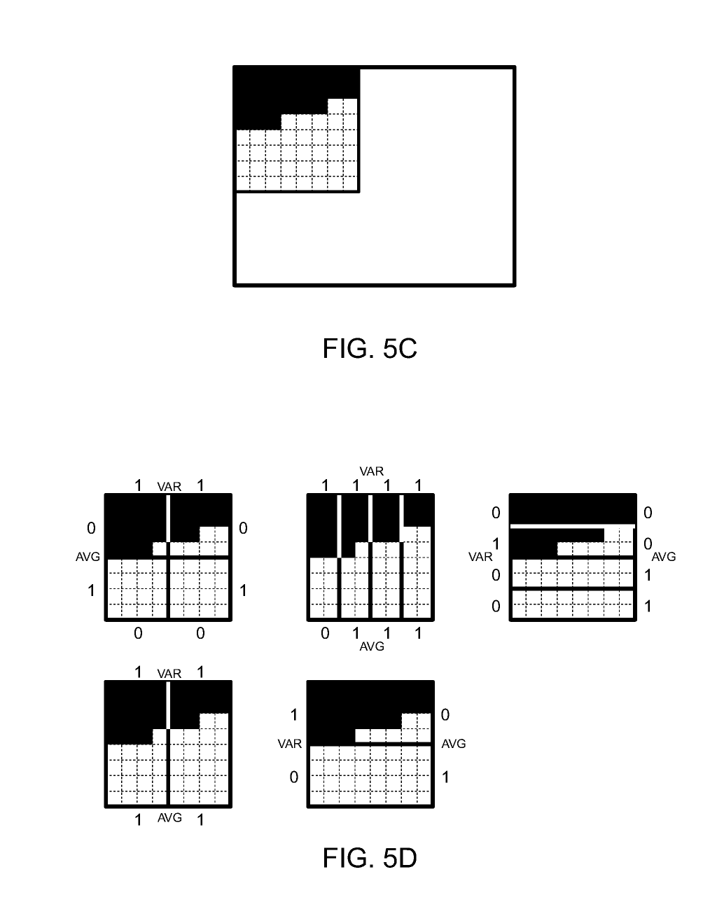

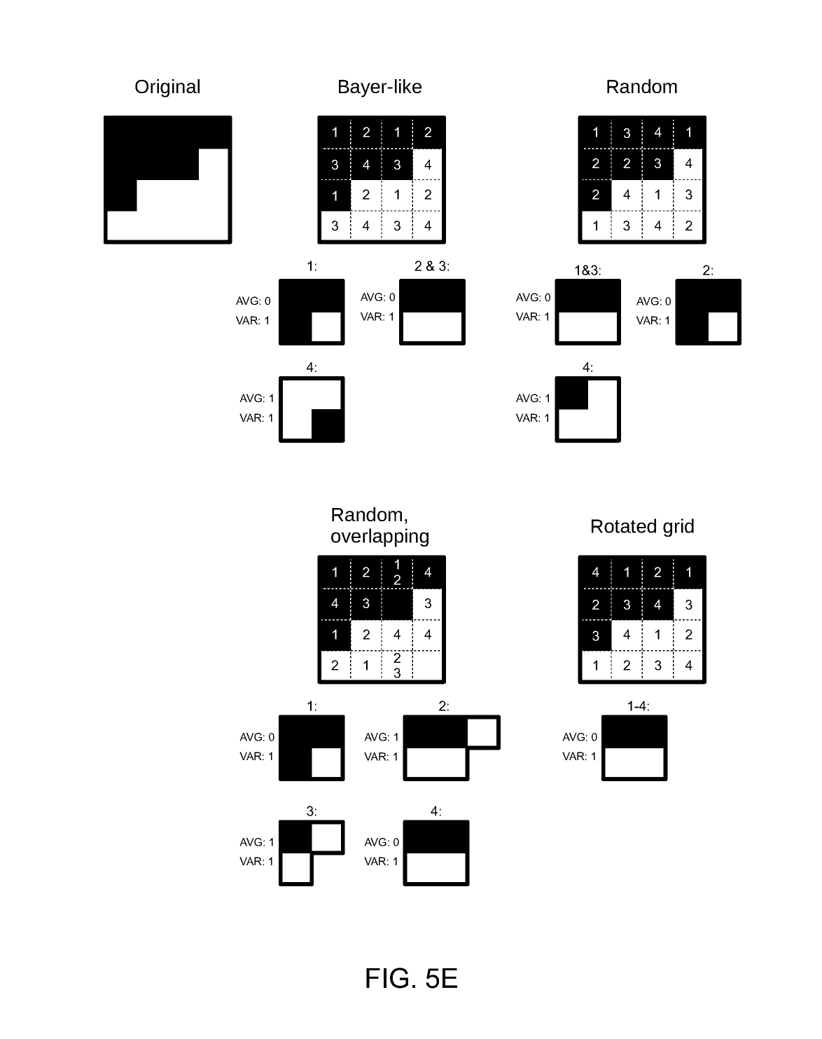

The invention is of further advantage in that databases employ in the apparatus, for example implemented as an encoder, are better optimized, when there does not need to be separate, for example flipped and rotated, copies of data blocks in the databases. This means that less database elements are needed in the databases, and more different data blocks can be found and reconstructed from those database elements. Reference here is made to appended FIG. 5A to FIG. 5E to exemplify such block transformations.

Optionally, the apparatus is operable in that searching is performed in (ii) subject to the data blocks (DB) being subjected to one or more transformations, and information is included in the compressed second data (D2) which is indicative of the one or more transformations.

Optionally, the apparatus is operable in (ii) to match the data blocks (DB) to corresponding elements (E) as a function of one or more parameters describing shapes of the data blocks (DB) and the elements (E). Optionally, it is advantageous to also search for and subsequently determine one or more transformations to be employed for the blocks, in order to succeed with search based on categories such as shape, mean, standard deviation, negation, adding/subtracting the mean, adding/subtracting the standard deviation, and so forth.

Optionally, the apparatus is operable to compress the first data (D1), wherein the first data (D1) includes at least one of: audio data, video data, image data, graphics data, seismic data, ECG data, measurement data, number data, character data, text data, Excel-type chart data, ASCII or Unicode character data, binary data, news data, commercial data, multidimensional data, DNA data, genomic data, but not limited thereto. The first data (D1) is, for example, generated by one or more sensors, so that the data (D1) is representative of a real physical variable, for example a spatial and/or angular light distribution, or an arrangement of groups of atoms in genetic biological material.

Optionally, in operation of the apparatus, the associated parameters (p1, p2, . . . ) describe at least one of: a flip transformation, a rotate transformation, a scaling transformation, a reorder transformation, a negation transformation, a transformation involving adding/subtracting/multiplying/dividing the mean, a transformation involving adding/subtracting/multiplying/dividing the standard deviation, a negation transformation, an adding/subtracting the mean transformation, an adding/subtracting the standard deviation transformation. An example of a database which either adds or subtracts the mean is a database whose elements were generated to have a zero mean. Therefore, these database elements can be easily used to code data blocks which contain a corresponding shape by transmitting only the reference to an element and its mean value, whether the original values of the data block had a small mean or a large mean. Multiplication and division can be used to remove easily the effect of amplitude from the blocks. Correspondingly, a particular shape of data blocks needs to be found in a database only once, because by using, for example, rotation or mirroring, this same shape of data can be moved also to another orientation in a corresponding decoding process in a decoder, namely when an image is being reconstructed in the decoder.

Optionally, the apparatus is operable to match the data blocks (DB) to their elements (E) by processing the plurality of sub-portion parameters (A1, A2, . . . , AN) via a plurality of look-up tables (LUT). More optionally, the apparatus is operable to match the data blocks (DB) to their elements (E) substantially irrespective of one or more transformations applicable to the data blocks (DB) and/or the elements (E) required to achieve representation of the data blocks (DB) via use of the elements (E) and their associated reference values (R). Optionally, a plurality of transformations is applicable to the data blocks (DB).

According to a second aspect, there is provided a method of using an apparatus for compressing first data (D1) to generate corresponding compressed second data (D2), wherein the method includes using computing hardware of the apparatus (10, 130) to arrange at least a portion of the first data (D1) into a configuration of data blocks (110, DB), characterized in that the method further includes:

(i) computing one or more parameters describing the data blocks (110, DB), the one or more parameters including a plurality of sub-portion parameters (A1, A2, . . . , AN) describing sub-portions of the data blocks (110, DB), wherein the plurality of sub-portion parameters (A1, A2, . . . , AN) includes at least one of: MAR (mean in amplitude ratio) mean, average, standard deviation, variance, amplitude, median, mode, minimum value, maximum value, CRC (cyclic redundancy check), hash, an amount of levels;

(ii) searching, based upon categories related to the one or more parameters, one or more databases and/or data base elements, for subsequent matching of the data blocks (110, DB) to corresponding matching elements (120, E) in the one or more databases (130), wherein the data blocks (110, DB) are matched to their corresponding matching elements (120, E) by utilizing the plurality of sub-portion parameters (A1, A2, . . . , AN);

(iii) for the matched data blocks (DB) and elements (E), generating a data set including reference values (R) identifying the elements (E) and containing the categories or information about the categories; and

(iv) generating the compressed second data (D2) by including therein the reference values (R) containing the categories or information about the categories.

Optionally, the method includes performing searching in (ii) subject to the data blocks (DB) being subjected to one or more transformations, and including information in the compressed second data (D2) which is indicative of the one or more transformations. More optionally, the one or more transformations include at least one of: a flip transformation, a rotate transformation, a scaling transformation, a reorder transformation, a negation transformation, a transformation involving adding/subtracting/multiplying/dividing the mean, a transformation involving adding/subtracting/multiplying/dividing the standard deviation, a negation transformation, an adding/subtracting the mean transformation, an adding/subtracting the standard deviation transformation.

Optionally, the method includes matching the data blocks (DB) to corresponding elements (E) as a function of one or more parameters describing shapes of the data blocks (DB) and the elements (E).

Optionally, the method includes compressing the first data (D1), wherein the first data (D1) includes at least one of: audio data, video data, image data, graphics data, seismic data, ECG data, measurement data, number data, character data, text data, Excel-type chart data, ASCII or Unicode character data, binary data, news data, commercial data, multidimensional data, DNA data, genomic data, but not limited thereto.

Optionally, in the method, the associated parameters (p1, p2, . . . ) describe at least one of: a flip transformation, a rotate transformation, a scaling transformation, a reorder transformation.

Optionally, the method includes matching the data blocks (DB) to their elements (E) by processing the plurality of sub-portion parameters (A1, A2, . . . , AN) via a plurality of look-up tables. More optionally, the method includes matching the data blocks (DB) to their elements (E) substantially irrespective of one or more transformations applicable to the data blocks (DB) and/or the elements (E) required to achieve representation of the data blocks (DB) via use of the elements (E) and their associated reference values (R).

According to a third aspect, there is provided a computer program product comprising a non-transitory computer-readable storage medium having computer-readable instructions stored thereon, the computer-readable instructions being executable by a computerized device comprising processing hardware to execute a method pursuant to the second aspect.

According to a fourth aspect, there is provided an apparatus for decompressing second data (D2) to generate corresponding decompressed third data (D3), characterized in that the apparatus includes a data processing arrangement which is operable:

(i) to extract from the second data (D2) one or more reference values (R) containing categories or information about the categories, wherein the categories are related to one or more parameters describing data blocks (110, DB), the one or more parameters including a plurality of sub-portion parameters (A1, A2, . . . , AN) describing sub-portions of the data blocks (110, DB), wherein the plurality of sub-portion parameters (A1, A2, . . . , AN) includes at least one of: MAR (mean in amplitude ratio) mean, average, standard deviation, variance, amplitude, median, mode, minimum value, maximum value, CRC (cyclic redundancy check), hash, an amount of levels;

(ii) to use the categories in respect of one or more elements (E) corresponding to the one or more reference values (R);

(iii) to collate together the one or more elements (E) subject to the categories from (ii) to generate a configuration of corresponding data blocks (DB); and

(iv) to output the decompressed third data (D3) including the configuration of data blocks (DB) from (iii).

Optionally, the apparatus is operable to perform searching in (ii) subject to the data blocks (DB) being subjected to one or more transformations defined in the second data (D2). More optionally, the one or more transformations include at least one of: a flip transformation, a rotate transformation, a scaling transformation, a reorder transformation, a negation transformation, a transformation involving adding/subtracting/multiplying/dividing the mean, a transformation involving adding/subtracting/multiplying/dividing the standard deviation, a negation transformation, an adding/subtracting the mean transformation, an adding/subtracting the standard deviation transformation.

Optionally, the apparatus is operable to decompress the second data (D2), wherein the second data (D2) includes at least one of: audio data, video data, image data, graphics data seismic data, ECG data, measurement data, number data, character data, text data, Excel-type chart data, ASCII or Unicode character data, binary data, news data, commercial data, multidimensional data, DNA data, genomic data, but not limited thereto.

Optionally, in operation of the apparatus, the associated parameters (p1, p2, . . . ) describe at least one of: a flip transformation, a rotate transformation, a scaling transformation, a reorder transformation.

According to a fifth aspect, there is provided a method of using an apparatus for decompressing second data (D2) to generate corresponding decompressed third data (D3), characterized in that the method includes:

(i) extracting from the second data (D2) one or more reference values (R) containing the categories or information about the categories, wherein the categories are related to one or more parameters describing data blocks (110, DB), the one or more parameters including a plurality of sub-portion parameters (A1, A2, . . . , AN) describing sub-portions of the data blocks (110, DB), wherein the plurality of sub-portion parameters (A1, A2, . . . , AN) includes at least one of: MAR (mean in amplitude ratio) mean, average, standard deviation, variance, amplitude, median, mode, minimum value, maximum value, CRC (cyclic redundancy check), hash, an amount of levels;

(ii) using the categories in respect of one or more elements (E) corresponding to the one or more reference values (R);

(iii) collating together the one or more elements (E) subject to the categories from (ii) to generate a configuration of corresponding data blocks (DB); and

(iv) outputting the decompressed third data (D3) including the configuration of data blocks (DB) from (iii).

Optionally, the method includes performing searching in (ii) subject to the data blocks (DB) being subject to one or more transformations defined in the second data (D2). More optionally, the one or more transformations include at least one of: a flip transformation, a rotate transformation, a scaling transformation, a reorder transformation, a negation transformation, a transformation involving adding/subtracting/multiplying/dividing the mean, a transformation involving adding/subtracting/multiplying/dividing the standard deviation, a negation transformation, an adding/subtracting the mean transformation, an adding/subtracting the standard deviation transformation.

Optionally, the method includes decompressing the second data (D2), wherein the second data (D2) includes at least one of: audio data, video data, image data, graphics data, seismic data, ECG data, measurement data, number data, character data, text data, Excel-type chart data, ASCII or Unicode character data, binary data, news data, commercial data, multidimensional data, DNA data, genomic data, but not limited thereto.

Optionally, in the method, the associated parameters (p1, p2, . . . ) describe at least one of: a flip transformation, a rotate transformation, a scaling transformation, a reorder transformation.

According to a sixth aspect, there is provided a computer program product comprising a non-transitory computer-readable storage medium having computer-readable instructions stored thereon, the computer-readable instructions being executable by a computerized device comprising processing hardware to execute a method pursuant to the fifth aspect.

It will be appreciated that it is not previously known that data blocks can be effectively pointed to, for example associated with, corresponding database elements in the databases via use of a plurality of relatively small look-up tables (LUT). Such an approach can be done to reduce the size of one or more look-up tables stored in data memory, wherein search references of database elements used utilize a larger set of values, namely a lot of bits for all partial references together.

Moreover, this invention enables the use of the same database element (E) for different data blocks, even when a given data block is first mirrored, flipped or reordered to match the shape information of a database element, if possible; such mirroring, flipping, or reordering is beneficially identified via the one or more aforementioned parameters describing the given data block.

The invention enables making database elements (E) more easily distinguishable, but they still represent a plurality of quite similar data blocks with similar shapes. This utilization of the shape of the database element (E) and of the shape of the data block (DB) enables a very accurate and fast data block search to be performed in operation in a given database. When the shape is also stored in respect of the database reference, it is desirable that the database block is always used uniquely, and the reconstruction will then be correspondingly correct.

Moreover, the invention provides a method of describing the shape of a database element (E), or a data block (DB), in respect of a database reference. This makes database elements (E) more easily distinguishable and thus makes searching in the database faster and more accurate. A search of a data block from a database with a database reference which contains shape information does not require as many elements (E) to be checked in parallel in comparison to a data block search from a database where the reference is without shape information. Therefore, the database elements (E) or data blocks with shape information are more relevant in the database.

Furthermore, an element (E) whose shape is similar to others is more useful than an element with a different shape, even if the content of the block is not perfect. Beneficially, the shape of the database element can be specified for the block by using one or more partial block reference elements. It is also possible to use mirrored, flipped, rotated or reordered versions of the same database elements (E), and in this way to save the amount of memory needed for storing the database, while still making it possible to have available a large number of different database elements (E). Additionally, the database elements can optionally have their own data values, which makes it possible to have content that is more suitable for the type of information to be encoded, namely compressed.

This invention makes it possible to use a relatively smaller number of database elements to represent a larger number of possible reconstruction blocks. Beneficially, this invention also provides a method that offers easier differentiation of otherwise similar reference valued data blocks by utilizing such information in sub-blocks that describe shape. This shape information in the sub-blocks speeds up data block searches in the database, and this shape information can also possibly be delivered within the reference value (R) directly or in modified manner. When searching for database elements (E), it is advantageous, as aforementioned, that such searches are conducted with help of categories such as shape, mean, standard deviation of data blocks (DB), and so forth. This shape information reduces the number of data values required by data value comparison that is otherwise needed to verify that a given data block is similar enough to a potentially corresponding database element. The comparisons are optionally still needed, but the amount of compared database elements is still considerably reduced, compared to known methods where shape information is not available based on sub-blocks in a data block and based on data block elements.

As aforementioned, databases can be used to speed up the execution of many different methods employed for embodiments of the present disclosure. For example, they can be used in speech recognition, musical notation recognition or text recognition (OCR), pattern recognition, for example in genome research for base pairs, in echo cancellation, for removing phantom images and for removing superfluous objects from the image and so forth. Moreover, the methods are usefully applied to data which is acquired using one or more sensors, for example a pixel imaging sensor, an electrophoresis RNA or DNA readout apparatus, and similar

Now, if for example phantom images or superfluous objects or echo are removed, such removal results in a corresponding missing piece of data that needs to be replaced by alternative data. For example, a background part of an image can be used to create suitable data to replace a removed part of phantom image, based on database references. Similar considerations pertain to echo cancellation, in which case a sequence of audio data where the echo has been removed will now only have original audio data, namely minus the echo. Such removal is optionally, for example for audio data, performed by convolution analysis which is an inverse of a mathematical function describing creation of an echo by superposition of a series of temporally delayed and filtered versions of the original audio data. However, this is a more straightforward process in a case of audio data than it is in case of images, because the echo actually needs to be recognized and it can be removed from the audio signal in practice. In contradistinction, it is generally not so simple merely to remove an object from an image, because there would thereby arise a blank area, for example a black area, where the object has been removed. Of course, if the speech of one person is removed from an audio signal sequence, then it needs to be replaced by, for example, comfort noise, or alternatively, with whatever audio signal remains left after the removal.

A database in such situations can be created, for example, in such a way that one database element (E) always corresponds the one alphanumeric character or to one musical notation symbol, and thus text recognition or generating musical notation can be executed directly based on references to the element (E). Moreover, as various different transformations can be used together with databases, then a dark text on a white background can, in certain situations, use the same database as a white text on a black background, namely when the database is used in combination with negation. Similarly, if the text is received via a mirror transformation, then based on the shape in the database and used in combination with mirroring, the text is easily recognizable and also easily codable.

According to a seventh aspect, there is provided an apparatus for compressing first data (D1) to generate corresponding compressed second data (D2), characterized in that the apparatus includes a data processing arrangement which is operable:

(i) to arrange the first data (D1) into a configuration of data blocks (DB);

(ii) to search using one or more gategories for matches of the data blocks (DB) in one or more databases for corresponding matching elements (E);

(iii) for the matched data blocks (DB) and elements (E), to generate a data set including reference values (R) identifying the elements (E) and their associated parameters (p1, p2, . . . ) defining the one or more gategories; and

(iv) to generate the compressed second data (D2) by including therein the reference values (R) and their associated parameters (p1, p2, . . . ) defining the one or more gategories.

According to an eighth aspect, there is provided an apparatus for decompressing second data (D2) to generate corresponding decompressed third data (D3), characterized in that the apparatus includes a data processing arrangement which is operable:

(i) to extract from the second data (D2) one or more reference values (R) and one or more associated parameters (p1, p2, . . . ) defining the one or more gategories;

(ii) to use the one or more gategories in respect of one or more elements (E) corresponding to the one or more reference values (R);

(iii) to collate together the one or more elements (E) subject to the one or more gategories from (ii) to generate a configuration of corresponding data blocks (DB); and

(iv) to output the decompressed third data (D3) including the configuration of data blocks (DB) from (iii).

Optionally, in the apparatus of the seventh and/or eighth aspect, the one or more gategories are based on shape, wherein the one or more gategories pertaining to an associated one or more data blocks are unchanged when the one or more data blocks are rotated and/or flipped.

It will be appreciated that features of the invention are susceptible to being combined in various combinations without departing from the scope of the invention as defined by the appended claims.

### DESCRIPTION OF THE DIAGRAMS

Embodiments of the present disclosure will now be described, by way of example only, with reference to the following diagrams wherein:

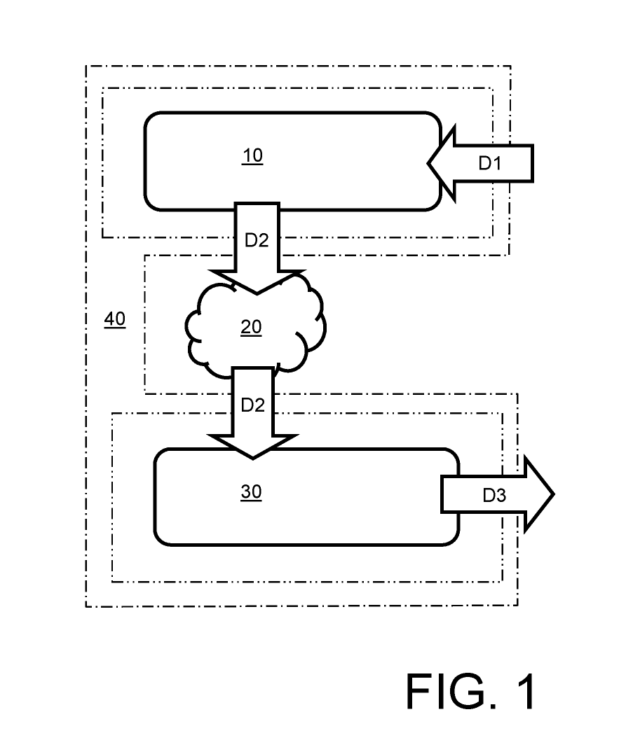

FIG. 1 is an illustration of a first apparatus for compressing source data D1 to generate corresponding compressed data D2, and a second apparatus for decompressing the compressed data D2 to generate corresponding decompressed data D3, wherein the first and second apparatus in combination are able to function as a codec;

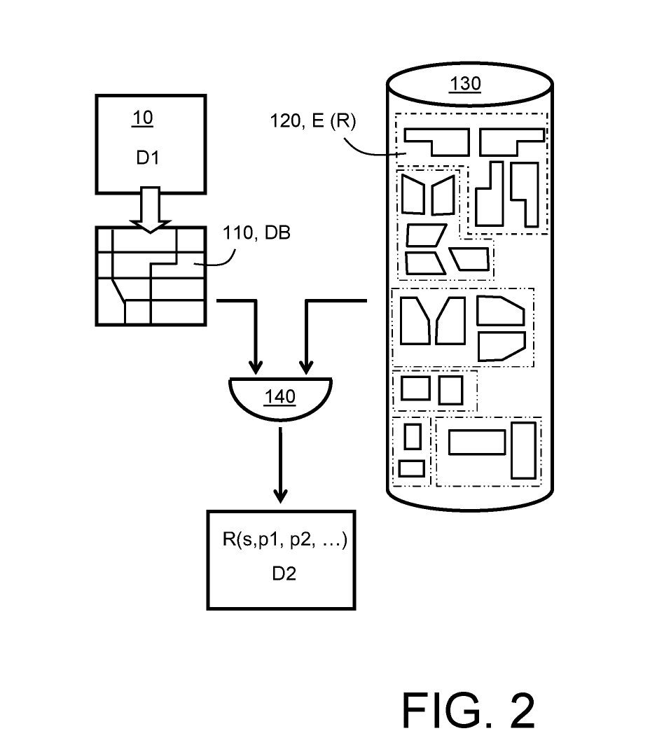

FIG. 2 is a pictorial illustration of a manner of data compression implemented within the first apparatus of FIG. 1;

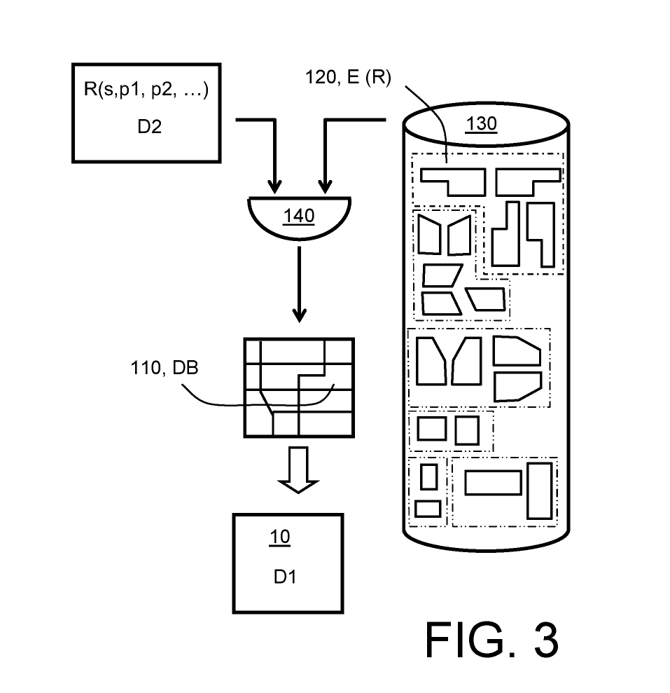

FIG. 3 is a pictorial illustration of a manner of data decompression implemented within the second apparatus of FIG. 1; and

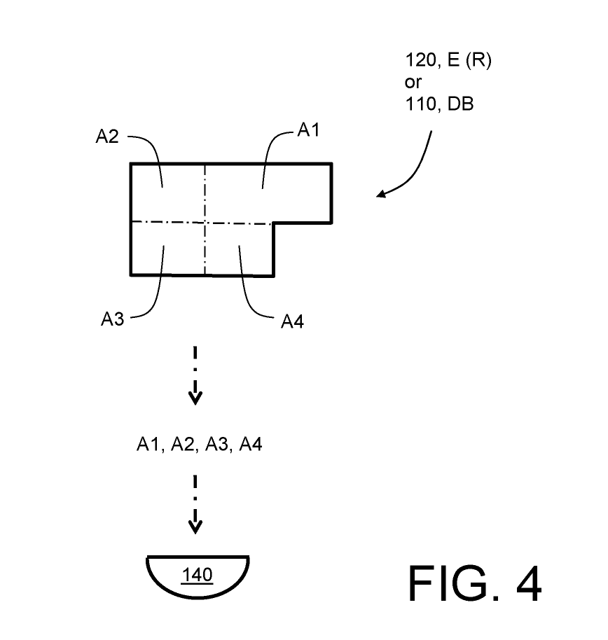

FIG. 4 is an illustration of a plurality of computations, including transformations, performed to characterize a given element E or a given data block DB to derive a plurality of characterizing parameters, for example a plurality of mean values, but not limited thereto, for use in the first and second apparatus of FIG. 1 for matching data blocks DB to corresponding elements E, for example when performing database searches amongst a group of elements E.

FIG. 5A to FIG. 5E are illustrations which represent different ways of utilizing shape information in categorizing elements E in a database, wherein:
in FIG. 5A, there is shown an example data block from an image;
in FIG. 5B, there is shown an example data block from FIG. 5A presented by way of a variety of transformation such as rotations and mirrorings, further including examples of average and variance bit values for sub-blocks;
in FIG. 5C, there is shown another example of a data block from an image;
in FIG. 5D, there is shown the example data block from FIG. 5C with a variety of samplings, further including examples of average and variance bit values for sub-blocks; and
in FIG. 5E, there are shown other examples of sampling, such as Bayer-like, random, overlapped and so forth.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EXAMPLE EMBODIMENTS

Embodiments of the disclosure will be described in overview, and thereafter specific examples of embodiments will be described in detail. Referring to FIG. 1, a data encoder 10 is operable to compress input data D1 to generate corresponding compressed data D2. The compressed data D2 is susceptible to being communicated via a data carrier and/or via a communication network, denoted by 20, to a data decoder 30. The data decoder 30 is operable to decompress the compressed data D2 to generate corresponding decompressed data D3. Optionally, the input data D1 and the decompressed data D3 are substantially mutually similar. In combination, the encoder 10 and the decoder 30 form a codec 40. Beneficially, the input data D1 is, for example, at least one of: audio data, video data, image data, graphics data, seismic data, ECG data, measurement data, number data, character data, text data, Excel-type chart data, ASCII or Unicode character data, binary data, news data, commercials data, multidimensional data, DNA data, genomic data, and so forth.

In the encoder 10, the input data D1 is compressed using one-dimensional data blocks or multi-dimensional data blocks. Moreover, the encoder 10 is beneficially operable to perform a data block search within one or more databases, in a manner which is faster than known searching approaches employed when performing data compression. Searching performed in the encoder 10 is, for example, based upon a comparison of one or more parameters, such as MAR (mean in amplitude ratio), mean, standard deviation, variance, amplitude, mode, median, min, max, index, the amount of levels and so forth. Moreover, the encoder 10 beneficially takes into account a shape of given data block being searched. The encoder 10 is thus arranged to perform additional computations which substantially avoids any ambiguity arising in operation when performing data block searches, mutatis mutandis the decoder 30 is correspondingly similarly arranged, as will be described in greater detail later.

It will be appreciated that not all data blocks in the input data D1 necessarily need to be encoded or compressed, correspondingly decoded and decompressed in a decoder, using a database. It is optionally feasible to employ other methods in combination the method pursuant to the disclosure, wherein the other methods include at least one of: a DC transform method (“direct current”, namely constant offset), a slide method, a line method, DCT (discrete cosine transform), a multilevel method and so forth, but not limited hereto. For implementing embodiments of the present disclosure, it is sufficient that at least one data block in the input data D1 is encoded or compressed, correspondingly decoded and decompressed in a decoder, using the method pursuant to the disclosure, to achieve a better data compression ratio.

It is known to employ cyclic redundancy check (CRC) and hash value computations to generate parameters that are susceptible to being used as a part of reference values for defining data blocks, but such parameters are not well suited for describing shapes of data blocks. It will be appreciated that data blocks are not necessarily rectangular, and can potentially have move complex shapes. For example, a small change in a shape of a given data block will yield a totally different computed CRC or hash value; moreover, a small change in a computed CRC or hash value for a first given data block and a second given data block does not mean that the first and second data blocks are mutually similar.

In overview, referring next to FIG. 2, the D1 is received at the encoder 10 and is expressed as a configuration of data blocks, for example including a data block DB, 110. During encoding of the data D1, the encoder 10 makes use of one or more databases, represented by 130. In the one or more databases 130 elements E, for example an element E, 120 is identified by a corresponding reference value R. The encoder 10 employs a comparison arrangement 140 wherein data blocks DB are matched to the elements E of the one or more databases 130. Such matching is potentially demanding in computational resources, but results in the generation of the encoded data D2 in which the reference values R are included, together with information, denoted by parameters p1, p2, . . . , which are indicative of one or more transformations applied to the elements E to enable them to represent their matched data blocks DB. During decoding of the data D2 in the decoder 30, the references R are extracted from the data D2 and corresponding elements E identified from one or more databases and appropriately transformed, defined by the parameters p1, p2, . . . also extracted from the data D2 to generate data blocks DB suitable for use in constructing the decoded data D3; such a process of reconstruction is illustrated in FIG. 3, wherein decoding of the data to reconstruct the data D1 is illustrated, namely the decoded data D3 is similar to the data D1 provided to the encoder 10.

The one or more databases 130 are optionally at least one of:

(i) integral to the encoder 10;

(ii) integral to the decoder 30;

(iii) spatially remote from the encoder 10 and/or the decoder 30;

(iv) shared between the encoder 10 and the decoder 30.

Optionally, a portion of the one or more databases 130 is local to the encoder 10 and/or the decoder 30, and another portion of the one or more databases 130 is spatially remote to the encoder 10 and/or the decoder 30.

Referring to FIG. 4, embodiments of the present disclosure employ a searching process, wherein a given data black DB or element E is compared by way of computing parameters A corresponding to sub-regions of the data block DB or element E, for example parameters A1 to A4 for different quadrants of the data block DB or element E. Searching in the encoding 10 is beneficially performed by comparing the parameters A1 to A4 for data blocks DB against parameters E of elements, because such an approach copes well with a situation that the element E in the one or more databases 130 is transformed in some manner relative to the data block DB, for example flipped, mirrored, rotated, scaled and so forth. This will be described in greater detail later. It will be appreciated that sub-regions implemented as quadrants is merely an example, and other sub-division of the regions is possible, for example octants and so forth. The one or more databases 130 are optionally implemented in one or more ways, as follows: in solid state memory, in one or more servers, in optical data storage media, in magnetic storage media, in quantum data storage wherein one bit of data is represented by one quantum. The one or more databases 130 are optionally spatially local to an encoder and/or a decoder. Alternatively, the one or more databases 130 are optionally spatially remote to an encoder and/or a decoder, for example coupled via one or more data communication networks.

Depending on an amount of bits used for expressing CRC or hash values, there might be one or more different data blocks DB that create mutually similar CRC or hash values; such CRC or hash values can be considered to be parameters describing data blocks. Moreover, a CRC or hash value expressed with a small amount of bits would have quantization errors. Even if a given pair of CRC or hash values are mutually similar, it does not mean that their corresponding data blocks are mutually similar, but often they are very different, if the given pair of CRC or hash values are not exactly the same. Typically, the CRC or hash value is totally different when only one value in a given data block is changed only a little. Thus, for implementing embodiments of the present disclosure, it will be appreciated that a better method is needed to describe similarities between data blocks with a parameter value that can somehow describe, for example, a shape of data block.

Optionally, in embodiments of the present disclosure, these CRC and Hash values are optionally used instead of an index, especially if it is desired to code in a lossless manner. In practice, however, it is beneficial to use an index in the encoder 10 and the decoder 30, because it is easier to define, namely it requires less computing resources, and it progresses in order, in sequence, which means that a new element can always be inserted into the database if there is enough space. If there were used CRC or a hash, then it might already be in use, and then a new element could not be inserted into the database.

Hash or CRC values are beneficially used, mainly to search for lossless data blocks, but with the help of quantizing also to search for lossy data blocks. A problem arising is, however, that lossy data blocks trigger false hits; conversely, in case of a lossy data block, a relatively small change can potentially cause a miss when seeking to match a data block. Therefore, in case of a lossy data block, an entire area defined by an index, a CRC or a hash should always be browsed through when implementing methods of the present disclosure, and in case of a lossless data block, a hit, namely a match, is beneficially verified by calculating an absolute difference for it.

Moreover, embodiments of the disclosure, that will be described in greater detail below, enable the use of a same given database element for different data blocks, even when the data block is first mirrored, flipped or reordered to match the shape information of a database element, where possible. Such embodiments are shown in the FIG. 5A to FIG. 5D.

Thus, in overview, embodiments of the present disclosure enable making database elements more easily distinguishable, whilst still enabling them to represent a multitude of mutually quite similar data blocks with mutually similar shapes. This utilization of shape information pertaining to the database element and to the shape of the data block enables a very accurate and fast data block search in the database to be implemented, thereby providing a fast and computationally efficient to compress data by way of describing the data via data blocks which are then associated with database elements, whose reference values are included in corresponding compressed data. When the shape information is also stored in the database reference, then the database block is always used uniquely, and the reconstruction will be correct in the decoder 30.

Data blocks and database elements usually contain multiple data values. When parameters such as MAR (mean in amplitude ratio), mean, standard deviation, variance, amplitude, median, mode, minimum, maximum, index, the amount of levels and so forth are defined for a data block or a database element, the parameters get similar values, even if the similar data block data values or database element values are in a different order. So such parameters are not dependent on the shape or order of the data block values, and thus would be sub-optimal to employ when searching one or more databases to match data blocks to corresponding elements in the one or more databases. In order to address such a sub-optimal situation, embodiments of the present disclosure employ advanced computations as will be described in greater detail below.

When a data block is divided into multiple parts that are overlapping or non-overlapping, the shape of data blocks can also be detected more accurately, for example in embodiments of the present disclosure. If the different parts create similar parameters for searching purposes, the shape or order of data values is also quite similar between the database element and its corresponding data block. The next example shows how a method pursuant to the present disclosure works.

A database can represent data values in one-dimensional data blocks or multi-dimensional data blocks. Optionally, a one-dimensional data block can be divided into one-dimensional sub-blocks or sections, and a two-dimensional data block can be divided to two-dimensional sub-blocks or sections. It is also possible to create a two-dimensional data block from a one-dimensional data block by creating sections so that they represent, for example scanline rows of the two-dimensional data. Similarly, a one-dimensional data block can be created by representing the two-dimensional data as all rows consequently.

If a one-dimensional data block contains sixteen values as follows in series Eq. 2:

10,20,25,30,10,15,20,25,15,15,15,20,20,15,10,20 Eq. 2

then those one-dimensional data block values can be represented in four data groups as follows in series Eq. 3:

10,20,25,30;10,15,20,25;15,15,15,20;20,15,10,20. Eq. 3

Moreover, those values can also be represented as a first two-dimensional data block as follows:

10,20,25,30,

10,15,20,25,

15,15,15,20,

20,15,10,20 Eq. 4

If this first two-dimensional data block is flipped horizontally, in respect of its vertical axis in respect of a manner as presented above, the second data block values will be as follows:

30,25,20,10,

25,20,15,10,

20,15,15,15

20,10,15,20 Eq. 5

If, for example, the mean is calculated for both data blocks Eq. 4 and Eq. 5, the result is the same, namely:

Mean1=Mean2=(3*10+5*15+5*20+2*25+1*30)/16=17.8125 Eq. 6

However, if the mean is calculated for each quarter of the data blocks, namely for four sub-blocks containing four samples each, there will be similar mean values for different data blocks, but they are in different quarters, namely:

Mean1_1=Mean2_2=(10+20+10+15)/4=13.75

Mean1_2=Mean2_1=(25+30+20+25)/4=25

Mean1_3=Mean2_4=(15+15+20+15)/4=16.25

Mean1_4=Mean2_3=(15+20+10+20)/4=16.25 Eq. 7

As a consequence, the data blocks can easily be distinguished from each other by using only those quarter mean values when performing a comparison, namely undertaking a search to match a given data block with elements included within one or more databases; in such a search, a situation may potentially arise where the first data block is in the database and the second data block is being searched in the database. It is also possible to detect a situation wherein, if the quarter mean values for the second data block are flipped horizontally, the values are similar to the quarter mean values for the first block.

It is possible to select samples, for example sub-blocks, namely make a selection, of the data blocks differently, for example in the aforementioned example of four-by-four 2D data block example; four rows, four columns, two halves for horizontal direction, two halves for vertical direction, two different diagonals with four samples, two different triangles with six samples, two different diagonals with ten samples, are feasible to employ. Any combination is optionally used to define shape parameters for a data block or a database element.

As the order of data-values in the data D1 changes, it is possible to detect that the block is different, and thus “sampling” is appropriate to employ, although it potentially does not produce a consistent database. Conversely, it mutually distinguishes datablocks in a simple and efficient manner.

In embodiments of the present disclosure, it is optionally possible to create bits or values to indicate which quarters:

(i) have the same mean value, for example 0 or 1;

(ii) have a higher mean, for example 1; or

(iii) have a lower mean, for example 0,

than the mean value of all data block samples. For example, in this simple binary case, the bits are then 0 1 0 0 for the first data block and 1 0 0 0 for the second data block.

In embodiments of the present invention, it is optionally possible to use more bits for each quarter, namely for each sub-block, to specify the mean or difference between means more accurately. For example:

X=sub block mean−whole block mean Eq. 8

Then, if X>4, there is (then) used binary 11. Conversely, if 4>=X>0, there is (then) used binary 10; here “>” denotes “greater than”, and “>=” denotes “greater than or equal to”. Moreover, if 0>=X>−4, there is (then) used binary 01, and if −4>=X, there is (then) used binary 00. Now, as a result, the bits for the first data block are 00 11 01 01, and for the second data block 11 00 01 01. For example, if the maximum value for the data is 31, with possible values in a range 0 to 31, namely defined by five-bit data, and three bits for expressing a mean are used, then X=mean div 4. Now, the values for the first data block are 3 6 4 4=011 110 100 100, and for the second data block as expressible as 6 3 4 4=110 011 100 100.

It will be appreciated that if the database elements are stored in the database as values that have no mean, namely in a form of a zero average, then also the sum of samples in the sub-block will indicate that the sub-block contains values that are smaller, namely negative, or higher, namely positive, relative to the block average.

Moreover, other parameters such as MAR (mean in amplitude ratio), standard deviation, variance, amplitude, median, mode, min, max, CRC, hash, the amount of levels and similar are optionally used instead of the mean value for describing the sub-blocks. For example, the parameter values for each quarter, namely sub-block, are 10, 20, 15, 10 for the first data block, and are 20, 10, 10, 15 for the second data block. It is also possible to use multiple parts, for example different values for different sub-blocks, for defining the shape of the data block more accurately.

These generated shape values, or bits, are beneficially used as a part of a reference value transmitted from the encoder 10, or they are beneficially used only to speed up the data block search in there aforementioned one or more databases. When the values are used also in the transmitted reference value, a clearly smaller range of index values is needed for the database reference, while a large amount of different database elements are still able to be referenced in the database uniquely and efficiently. The delivery of elected descriptions of a corresponding database element is also possible to do by using a flip bit, a rotate bit, a mirror bit, a reorder information bit, and so forth, in the transmitted database reference. It is also optionally possible to combine such items of information so that:

(i) “000” means normal;

(ii) “001” means horizontally flipped;

(iii) “010” means vertically flipped;

(iv) “011” means rotated by 90o degree in a right-hand direction;

(v) “100” means rotated by 90o in a left-hand direction;

(vi) “101” means rotated by 180o degree, namely flipped horizontally and vertically;

(vii) “110” means quarters in order 0213; and

(viii) “111” means quarters in order 3120.

This information is optionally entropy encoded in the encoder 10, namely in a similar manner to other partial reference information.

Optionally, negation values can be used, and this kind of information can also be transmitted between the encoder 10 and the decoder 30. Moreover, negation values are optionally used for original data block values or for difference block values. For example, if the negation block is generated for the first data block, for a range of values from 0 to 31 in this example, then the values are:

21,11,06,01,

21,16,11,06,

16,16,16,11,

11,16,21,11 Eq. 9

A mean is then optionally computed for this data block, as follows:

Mean3=(3*21+5*16+5*11+2*6+1*1)/16=13.1875=31−Mean1 Eq. 10

Similarly, when mean values are computed for each quarter of the data blocks, namely four sub-blocks containing four samples each, then the mean values for the data block quarters are:

Mean3_1=(21+11+21+16)/4=17.25=31−Mean1_1

Mean3_2=(6+1+11+6)/4=6=31−Mean1_2

Mean3_3=(16+16+11+16)/4=14.75=31−Mean1_3

Mean3_4=(16+11+21+11)/4=14.75=31−Mean1_4 Eq. 11

Moreover, a data block including negation values can be searched in the aforementioned one or more databases very efficiently. There are also many other types of data blocks that can be described by the database reference, and that can also be created based upon a given delivered block reference. These other types of data blocks optionally contain some kind of shape information, and also other information that changes the referenced database element values in a specified way, and thereby, for example, also changes a data block that is used in a reconstruction of a resulting data at the decoder 30.

When shape information is used in the data block search from the one or more databases, it is beneficial that there is shape information, namely sub-block reference values, available that were already calculated earlier for all database elements. It is also possible to search those different combinations, for example flip, rotate, negation, by modifying the data block that is searched for, or at least its reference values, and then to make an attempt to find it, or at least these modified reference values in the one or more databases; examples of transformations such as flip, rotate, negation and so forth are illustrated in FIG. 5A to FIG. 5E

It will be appreciated that reference values are individualizing values that point to a certain element (E), or a group of elements (E) when several elements (E) are used, in a database, for example implemented as aforementioned. Conversely, “shape” information pertaining to a large data block describes a reference value of the large data block, for example the properties of a sub-block in the larger data block. That is, the shape information, usually a bit value, does not actually point to an element in a database for the size of the sub-block, but they can be constructed from the attributes, i.e. parameters, of sub-blocks of the large data block. From the same attributes, for the sub-block, a reference value is optionally constructed for a database that is there for data blocks which have the same size as the sub-block, if necessary. However, different formulae are beneficially used, and in this case, they would actually point to a database element or to a group of elements. In other words, a common factor here is attributes, and therefore it is both sensible and efficient to calculate these attributes, even when the data block cannot be found in the large database, and even though there would later be a need to search for the data block in a smaller database.

Depending upon an overall encoding method employed in the encoder 10, correspondingly an overall method employed in the decoder 30, it is optionally beneficial to create sub-blocks for shape information. For example, if it is known that there are 16×16, 8×8 and 4×4 databases available, then it is feasible immediately to compute all reference values for 4×4 blocks, or even for 2×2 blocks, and thereafter, based on those created reference values, also for 8×8 and 16×16 blocks. Now, for 16×16 blocks, all reference values are available, similarly also sub-block reference values, for example 8×8 quarters that describe the block more accurately. It will also be appreciated that those sixteen 4×4 blocks can also optionally be used for a 16×16 block to define the shape even more accurately. Moreover, it is optionally feasible to use sampling to calculate the various attributes, namely parameter values, which means that, in theory, the actual sub-blocks do not even exist, but instead they are samples selected from the original data block, whether or not they were in a sub-block or were sampled. However, the attributes of the sub-blocks are necessary to be calculated, if it is desired to run a search in the database in question, and the database contains sub-block data. Here, the attributes are beneficially always calculated, so that the search can be conducted in a faster manner. An embodiment employing Bayer sampling is presented in FIG. 5E.

In principle, a given database that contains elements corresponding to the 4×4 blocks could be used both for audio and for images/video, even though audio signals often behave very differently in comparison to video, and therefore it is usually advantageous to create dedicated databases for audio data. In case of audio data, the bit depth of data values is often larger than, for example, 16/24 bits, whereas in images, bit depth is often 8 bits but even 10/12/14/16 bits can be used in practice. Of course, separate colour channel values can be used in an interleaved manner, so that, for example, 24 bit values are employed for the combined three channels.

However, such a 24-bit database that contains 8-bit values of three colour channels is rather different from a database that contains 24-bit audio samples. For the 24-bit database that contains 8-bit interleaved values of three colour channels, it is advantageous to execute all transformations in such a way that the three 8-bit values, for example the mean, are processed separately, for example always processed separately, whereas the 24-bit one-value audio database elements, for example indicative of the mean, are processed as one value in the transformations.

It will be appreciated that the data block is optionally scaled up or down, for example when encoding data in the encoder 10, wherein the reference values for data blocks or its sub blocks are not changed, in a reasonable manner, if a scaling algorithm employed is appropriately implemented. Optionally, small modifications, for example to amplitude, are implemented, because a smaller amount of data values cannot represent the same frequency information than a higher amount of data values can do, namely not without aliasing the data content.

When the shape information is added to the transmitted, namely static, database element reference value, for example, in the encoded data D2, then the reference optionally contains, for example a mean value with 8 bits, an amplitude with 3 bits, a standard deviation that is dependent on amplitude with 3 bits, shape information with 4 bits (namely mean difference for quarters), shape information with 4 bits (namely amplitude for vertical slices), a block order value, a flip value, a rotate value and negation information with 3 bits, and index with 2 bits for different combinations to an otherwise similar reference value.

It will be appreciated that the shape information can also be used with dynamic database elements. A static database is a database which contains a fixed amount of constant elements, whereas in a dynamic database, database elements can be dynamically changed, namely inserted and removed thereto and therefrom.

The search for a database element or a data block can be performed also using one or multiple look-up tables (LUT). To perform such a fast database search, the database element and/or data block are optionally also divided into sub-elements or sub-blocks. In such a case, a single computational reference value is beneficially calculated, namely computed, from combined reference values, or from multiple data values of sub-elements or sub-blocks. If only one loop-up table is used in the search, the size of the table must be large enough to store a certain amount of computational reference values and pointers to the database elements or transmitted reference values that uniquely describe the database element. In embodiments of the present disclosure, searches in databases for transformations pertaining to data blocks (DB) is conducted based on categories such as shape, mean, standard deviation and similar.

Optionally, multiple loop-up tables are employed in the search, but then the computational reference values must be computed using different data values or different algorithms in comparison to the computational references of the other used loop-up tables. It is highly desirable that computational reference values for multiple loop-up tables be related to each sub-element or sub-block, or else an achievable accuracy during encoding in the encoder 10, similarly during decoding in the decoder 30, will easily be lost.

Beneficially, the size of a transmitted reference value is optimally calculated, namely computed, for a database element, and its value is searched for the data block. After the search, it is usually written or sent to the encoded data D2 and therefore it should not use more bits than necessary during encoding processes executed in the encoder 10, namely just enough to make the database element unique. A computational database reference beneficially uses more accurate references, so as to enable a fast search of the database element to be performed for the data block, so that it can be distinguished from other computational reference values in a loop-up table for one database element.

Each database element optionally has multiple computational references. It is also possible that one computational reference “offers” multiple database elements in a loop-up table, when the computational references are short; thus, the used loop-up tables are also small, but then the results of multiple tables should be compared, and only those database elements that are valid are available for all loop-up tables' computational references. For example, a 4×4 data block consists of four corresponding 2×2 sub-elements or sub-blocks, wherein every sub-element or sub-block has its own computational database reference value, which may consist of multiple data values such as shape, MAR (mean amplitude in ratio), mean, standard deviation, variance, amplitude, median, mode, min, max, CRC, hash, amount of levels, and so forth. Each computational reference value of combined sub-elements, or all sub-blocks, are stored into their own loop-up table with a chronological number or a pointer to a database element or a transmitted reference value.

When searching for a given data block from among the database elements, success is indicated if every sub-element or sub-block of the data block are linked into a same corresponding database element in the loop-up tables by way of the computational reference values. This is a very fast searching method compared to known types of searching methods, but not thoroughly accurate. On account of a “pigeonhole principle” employed, it cannot be true in all cases, see Reference [1] in the APPENDIX later. If a fast searching method is used with one or multiple tables, then the one or more resulting database elements are beneficially confirmed by comparing them to the source data block, before it is accepted for encoding into the encoded data D2, in the encoder 10.

The encoder 10 and the decoder 30 are susceptible to being utilized in a wide range of apparatus, for example personal computers, phablet computers, tablet computers, smart phones, consumer audio-visual apparatus, gaming apparatus, scientific instruments, communication systems, vehicles, aircraft, satellites, data communication systems, in-vehicle apparatus, automotive apparatus and similar. The encoder 10 and the decoder 30 are beneficially implemented using data processing hardware, for example using computing hardware operable to execute one or more software products recorded on non-transient machine-readable data storage media and/or in customized digital hardware.

Embodiments of the present disclosure make it possible to use a smaller amount of database elements to represent a larger amount of possible reconstructed blocks in the decoder 30. Moreover, embodiments of the present disclosure also utilize a method that offers easier differentiation of otherwise similar reference valued data blocks by utilizing such information in the sub-blocks that describe shape. This shape information speeds up the data block search in one or more databases, and this shape information is optionally delivered within the reference value directly or in a modified manner. This shape information reduces an amount of data-value-by-data-value comparison that is otherwise needed to verify that the data block is similar enough to the database element. The comparisons are optionally still needed, but the amount of compared database elements is still reduced considerably, compared to known methods wherein shape information based upon sub-blocks in a data block and on data block elements is not utilized.

In embodiments of the disclosure, shape information is delivered as an own separate category element in a reference, but without delivery of transformation information, for defining one or more transformations, and information pertaining to use of such transformation information. Moreover, in such embodiments, sub-block attribute information can create, for example, a bit pattern that describes a variance of the sub-blocks, for example 1 1 0 0, which means that two quadrants, namely top-left and top-right quadrants, contain information with significant variance and two other quadrants, namely bottom-left and bottom-right, are flat sub-blocks in a corresponding main block. Such an approach, as will be appreciated from shape examples in FIG. 5A to FIG. 5E, then enables a new four-bit category (referred to as “gategory” as the category is employed for searching purposes in databases, namely for performing data gating during searching activities) of describing database elements, which can be used:

(i) to speed up searches in databases;

(ii) to be used for reference delivery; and

(ii) to enable guesses or estimations to be made for one or more transformations,

when the amount of “1”'s and “0”'s bits are the same in some other block, but the order of the bits concerned is different. For example, if another block has a bit pattern 0 1 0 1, namely top-right and bottom-right sub-blocks contains variance and top-left and bottom-left are flat, then such a type of block is potentially susceptible to being coded with a previous type of database element, for 1 1 0 0 blocks that is subject to a transformation involving a 90° rotation in a right-hand direction.

A “gategory”, as aforementioned, may contain various different amounts of bits, depending on how the splitting into sub-blocks is executed. Typical bit counts for a category bit pattern are 2, 8, 3, 5, in addition to the bit count 4 used in the example above. Similarly, a “gategory” may also describe different types of thresholded information, pertinent when performing searching in databases. In the example above, a bit in the bit pattern always describes either a large or a small variance value in a sub-block; however, a bit in the bit pattern optionally describes a large or a small mean value, or some other property of a given sub-block in question.

It should be appreciated that “category” of a data block or of a database or of the database element can contain one or more “gategories”, based on different properties, namely parameters, of the data block or of the database or of the database element.

It will be appreciated that such an approach provides a new type of element which is shape dependent, namely changes if an associated block is rotated or flipped, and that such a change is predictable; such a benefit is not provided, in comparison, with CRC or hash values, wherein changes of CRC and hash values are not possible to predict when an associated block is rotated, flipped or contains noise.

Optionally, it is feasible to deliver an aforementioned “gategory” by employing two bits that describe the count of flat sub-blocks; a “flat sub-block” is one that does not contain significant variance therein. In such case, values 0, 1, 2 and 3 are valid, because the value 4 means that the whole block is flat, and this is typically not coded via use of databases, or, if the block is coded via use of databases, then the gategory can be defined with full attributes; in other words, sub-block gategories are not needed. In this example, the gategory is also based on shape, for example how many sub-blocks contain flat elements, but the gategory does not change when the block is rotated or flipped.

Although the examples and description above deal with data blocks, the processes and transformations that can be used for data blocks can also be used for packets of data, for example audio packets, such as audio frames, chunks of audio samples, and similar. Audio packets can also be split into sub-packets, for example into 2, 3 or 4 sub-packets. The examples above should therefore not limit the scope of protection. For example, audio packets are optionally split depending upon their Fourier harmonic content, such that splitting of the audio packets occurs in respect of frequency, and searching is based upon comparing and matching audio Fourier components. Similar considerations pertain mutatis mutandis to spatial Fourier frequency of images.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. An apparatus (10, 130) for compressing first data (D1) to generate corresponding compressed second data (D2), characterized in that the apparatus (10, 130) includes a data processing arrangement which is operable:
(i) to arrange the first data (D1) into a configuration of data blocks (110, DB);
(ii) to compute one or more parameters describing the data blocks (110, DB) and, based upon categories related to the one or more parameters, to search one or more databases and/or data base elements, for subsequent matching of the data blocks (110, DB) in the one or more databases (130) for corresponding matching elements (120, E);
(iii) for the matched data blocks (110, DB) and elements (120, E), to generate a data set including reference values (R) identifying the elements (120, E) and containing the categories or information about the categories; and
(iv) to generate the compressed second data (D2) by including therein the reference values (R) containing the categories or information about the categories.

2. An apparatus (10, 130) as claimed in claim 1, characterized in that searching is performed in (ii) subject to the data blocks (DB) being subject to one or more transformations, and information is included in the compressed second data (D2) which is indicative of the one or more transformations.

3. An apparatus (10, 130) as claimed in claim 2, characterized in that the one or more transformations include at least one of: a flip transformation, a rotate transformation, a scaling transformation, a reorder transformation, a negation transformation, a transformation involving adding/subtracting/multiplying/dividing the mean, a transformation involving adding/subtracting/multiplying/dividing the standard deviation, a negation transformation, an adding/subtracting the mean transformation, an adding/subtracting the standard deviation transformation.

4. An apparatus (10, 130) as claimed in claim 1, 2 or 3, characterized in that the apparatus (10) is operable in (iii) to match the data blocks (110, DB) to corresponding elements (E, 120) as a function of one or more parameters describing shapes of the data blocks (DB, 110) and the elements (E, 120).

5. An apparatus (10, 130) as claimed in claim 1, 2, 3 or 4, characterized in that the apparatus (10) is operable to compress the first data (D1), wherein the first data (D1) includes at least one of: audio data, video data, image data, graphics data, seismic data, ECG measurement data, numbers data, character data, text data, Excel-type chart data, ASCII data, Unicode character data, binary data, news data, commercials data, multi-dimensional data, DNA data, genomic data.

6. An apparatus (10, 130) as claimed in any one of claims 1 to 5, characterized in that the associated parameters (p1, p2, . . . ) describe at least one of: a flip transformation, a rotate transformation, a scaling transformation, a reorder transformation.

7. An apparatus (10, 130) as claimed in any one of claims 1 to 6, characterized in that the apparatus (10) is operable to match the data blocks (DB, 110) to their elements (E, 120) by utilizing a plurality of sub-portion parameters (A1, A2, . . . , AN) describing sub-portions of the data blocks (DB, 110) and/or the elements (E, 120) and by matching using the plurality of parameters (A1, A2, . . . , AN).

8. An apparatus (10, 130) as claimed in claim 7, characterized in that the apparatus (10) is operable to match the data blocks (DB, 110) to their elements (E, 120) by processing the plurality of sub-portion parameters (A1, A2, . . . , AN) via a plurality of look-up tables.

9. An apparatus (10, 130) as claimed in claim 7 or 8, wherein the apparatus (10) is operable to match the data blocks (DB, 110) to their elements (E, 120) substantially irrespective of one or more transformation applicable to the data blocks (DB, 110) and/or the elements (E, 120) required to achieve representation of the data blocks (DB, 110) via use of the elements (E, 120) and their associated reference values (R).

10. An apparatus (10, 130) as claimed in claim 7, 8 or 9, characterized in that the plurality of sub-portion parameters (A1, A2, . . . , AN) includes at least one of: MAR (mean in amplitude ratio) mean, average, standard deviation, variance, amplitude, median, mode, minimum value, maximum value, CRC, hash, the amount of levels.

11. A method of using an apparatus (10, 130) for compressing first data (D1) to generate corresponding compressed second data (D2), characterized in that the method includes:
(i) using computing hardware of the apparatus (10, 130) to arrange the first data (D1) into a configuration of data blocks (110, DB);
(ii) computing one or more parameters describing the data blocks (110, DB) and, based upon categories related to the one or more parameters, searching one or more databases and/or data base elements, for subsequent matching of the data blocks (110, DB) in the one or more databases (130) for corresponding matching elements (120, E);
(iii) for the matched data blocks (110, DB) and elements (120, E), generating a data set including reference values (R) identifying the elements (120, E) and containing the categories or information about the categories; and
(iv) generating the compressed second data (D2) by including therein the reference values (R) and containing the categories or information about the categories.

12. A method as claimed in claim 11, characterized in that the method includes performing searching in (ii) subject to the data blocks (DB) being subject to one or more transformations, and including information in the compressed second data (D2) which is indicative of the one or more transformations.

13. A method as claimed in claim 12, characterized in that the one or more transformations include at least one of: a flip transformation, a rotate transformation, a scaling transformation, a reorder transformation, a negation transformation, a transformation involving adding/subtracting/multiplying/dividing the mean, a transformation involving adding/subtracting/multiplying/dividing the standard deviation, a negation transformation, an adding/subtracting the mean transformation, an adding/subtracting the standard deviation transformation.

14. A method as claimed in claim 11, 12 or 13, characterized in that the method includes matching the data blocks (110, DB) to corresponding elements (E, 120) as a function of one or more parameters describing shapes of the data blocks (DB, 110) and the elements (E, 120).

15. A method as claimed in claim 11, 12, 13 or 14, characterized in that the method includes compressing the first data (D1), wherein the first data (D1) includes at least one of: audio data, video data, image data, graphics data, seismic data, ECG measurement data, numbers data, character data, text data, Excel-type chart data, ASCII data, Unicode character data, binary data, news data, commercials data, multi-dimensional data, DNA data, genomic data.

16. A method as claimed in any one of claims 11 to 15, characterized in that the associated parameters (p1, p2, . . . ) describe at least one of: a flip transformation, a rotate transformation, a scaling transformation, a reorder transformation.

17. A method as claimed in any one of claims 11 to 16, characterized in that the method includes matching the data blocks (DB, 110) to their elements (E, 120) by utilizing a plurality of sub-portion parameters (A1, A2, . . . , AN) describing sub-portions of the data blocks (DB, 110) and/or the elements (E, 120) and by matching using the plurality of parameters (A1, A2, . . . , AN).

18. A method as claimed in claim 17, characterized in that the method includes matching the data blocks (DB, 110) to their elements (E, 120) by processing the plurality of sub-portion parameters (A1, A2, . . . , AN) via a plurality of look-up tables.

19. A method as claimed in claim 17 or 18, characterized in that the method further includes matching the data blocks (DB, 110) to their elements (E, 120) substantially irrespective of one or more transformation applicable to the data blocks (DB, 110) and/or the elements (E, 120) required to achieve representation of the data blocks (DB, 110) via use of the elements (E, 120) and their associated reference values (R).

20. A method as claimed in claim 17, 18 or 19, characterized in that the plurality of sub-portion parameters (A1, A2, . . . , AN) includes at least one of: MAR (mean in amplitude ratio), mean, average, standard deviation, variance, amplitude, median, mode, minimum value, maximum value, CRC, hash, the amount of levels.

21. A computer program product comprising a non-transitory computer-readable storage medium having computer-readable instructions stored thereon, the computer-readable instructions being executable by a computerized device comprising processing hardware to execute a method as claimed in any one of claims 11 to 20.

22. An apparatus (30, 130) for decompressing second data (D2) to generate corresponding decompressed third data (D3), characterized in that the apparatus (30) includes a data processing arrangement which is operable:
(i) to extract from the second data (D2) one or more reference values (R) containing the categories or information about the categories
(ii) to use the one or more categories in respect of one or more elements (E, 120) corresponding to the one or more reference values (R);
(iii) to collate together the one or more elements (E, 120) subject to the one or more categories from (ii) to generate a configuration of corresponding data blocks (DB, 110); and
(iv) to output the decompressed third data (D3) including the configuration of data blocks (DB, 110) from (iii).

23. An apparatus (30, 130) as claimed in claim 22, characterized in that the apparatus (30, 130) is operable to perform searching in (ii) subject to the data blocks (DB) being subject to one or more transformations defined in the second data (D2).

24. An apparatus (30, 130) as claimed in claim 23, characterized in that the one or more transformations include at least one of: a flip transformation, a rotate transformation, a scaling transformation, a reorder transformation, a negation transformation, a transformation involving adding/subtracting/multiplying/dividing the mean, a transformation involving adding/subtracting/multiplying/dividing the standard deviation, a negation transformation, an adding/subtracting the mean transformation, an adding/subtracting the standard deviation transformation.

25. An apparatus (30, 130) as claimed in claim 22, characterized in that the apparatus (30, 130) is operable to decompress the second data (D2), wherein the second data (D2) includes at least one of: audio data, video data, image data, graphics data seismic data, ECG measurement data, numbers data, character data, text data, Excel-type chart data, ASCII data, Unicode character data, binary data, news data, commercials data, multi-dimensional data, DNA data, genomic data.

26. An apparatus (30, 130) as claimed in claim 22, 23, 24 or 25, characterized in that the associated parameters (p1, p2, . . . ) describe at least one of: a flip transformation, a rotate transformation, a scaling transformation, a reorder transformation.

27. A method of using an apparatus (30, 130) for decompressing second data (D2) to generate corresponding decompressed third data (D3), characterized in that the method includes:
(i) extracting from the second data (D2) one or more reference values (R) containing the categories or information about the categories;
(ii) using the one or more categories in respect of one or more elements (E, 120) corresponding to the one or more reference values (R);
(iii) collating together the one or more elements (E, 120) subject to the one or more categories from (ii) to generate a configuration of corresponding data blocks (DB, 110); and
(iv) outputting the decompressed third data (D3) including the configuration of data blocks (DB, 110) from (iii).

28. A method as claimed in claim 27, characterized in that the method includes apparatus (30, 130) is operable to perform searching in (ii) subject to the data blocks (DB) being subject to one or more transformations defined in the second data (D2).

29. A method as claimed in claim 28, characterized in that the one or more transformations include at least one of: a flip transformation, a rotate transformation, a scaling transformation, a reorder transformation, a negation transformation, a transformation involving adding/subtracting/multiplying/dividing the mean, a transformation involving adding/subtracting/multiplying/dividing the standard deviation, a negation transformation, an adding/subtracting the mean transformation, an adding/subtracting the standard deviation transformation.

30. A method as claimed in claim 27, 28 or 29, characterized in that the method includes decompressing the second data (D2), wherein the second data (D2) includes at least one of: audio data, video data, image data, graphics data, seismic data, ECG measurement data, numbers data, character data, text data, Excel-type chart data, ASCII data, Unicode character data, binary data, news data, commercials data, multi-dimensional data, DNA data, genomic data.

31. A method as claimed in claim 27, 28, 29 or 30, characterized in that the associated parameters (p1, p2, . . . ) describe at least one of: a flip transformation, a rotate transformation, a scaling transformation, a reorder transformation.

32. A computer program product comprising a non-transitory computer-readable storage medium having computer-readable instructions stored thereon, the computer-readable instructions being executable by a computerized device comprising processing hardware to execute a method as claimed in any one of claims 27 to 31.
